(19) United States
(12) Patent Application Publication
(10) Pub. No.: US 2015/0332107 A1
(43) Pub. Date: Nov. 19, 2015

(54) AN APPARATUS AND ASSOCIATED METHODS

(71) Applicant: NOKIA TECHNOLOGIES OY, Espoo (FI)

(72) Inventor: Yannis Paniaras, Vienna, VA (US)

(21) Appl. No.: 14/655,092

(22) PCT Filed: Dec. 24, 2012
(86) PCT No.: PCT/CN2012/087337

§ 371 Date: Jun. 24, 2015

(51) Int. Cl. G06K 9/20; G06F 3/0481

(52) U.S. Cl. CPC G06K 9/2054; G06F 3/0481

(57) ABSTRACT

An apparatus, the apparatus comprising at least one processor, and at least one memory including computer program code, the at least one memory and the computer program code configured, with the at least one processor, to cause the apparatus to perform at least the following: during a detected interaction with a graphical user interface element, provide a highlight associated with the graphical user interface element, the size of the highlight dependent upon the size of the graphical user interface element prior to the detected interaction.

### TECHNICAL FIELD

The present disclosure relates to user interfaces, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

A user may be able to interact with items displayed on a screen of an electronic device. For example, a user may be able to slide a scroll bar to read further down a page of displayed text, double click on an icon to open an application, drag an image from one area of the screen to another, or select an option by clicking on a box. If the device is an electronic device with a touch-sensitive display screen, the user may be able to interact with the displayed items by using his finger or a stylus on the screen. If not, a keyboard or mouse can be used.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus, the apparatus comprising at least one processor, and at least one memory including computer program code, the at least one memory and the computer program code configured, with the at least one processor, to cause the apparatus to perform at least the following:
during a detected interaction with a graphical user interface element, provide a highlight associated with the graphical user interface element, the size of the highlight dependent upon the size of the graphical user interface element prior to the detected interaction.

An example of a detected interaction is the pre-selection of a graphical user interface element, for example by a user hovering a finger over an graphical user interface element displayed on a hover-sensitive screen or by positioning a mouse controlled on-screen pointer over the graphical user interface element. Another example of a detected interaction is movement of the graphical user interface element, for example by sliding a slider or scroll bar, or dragging an icon across a display to move it. A further example of a detected interaction is actuation of a graphical user interface element, for example by clicking/double clicking an icon or button to open an associated application, clicking a “close” option to close a window or application, and tapping a menu option to cause a dialog box to open.

A highlight may be considered some element of feedback provided so that the user is made aware that they he/she has interacted with a graphical user interface element, and that the interaction has been detected. Highlighting may be advantageous for a user. For example if a user wants to select one option from several displayed options, highlighting can help make the user aware of which of the options he/she has actually selected. The highlighting may also be advantageous to the user to indicate what type of interaction has been detected, for example, whether a selection or a movement interaction has been made.

The highlight may be one or more of a visual highlight, an audio highlight and a haptic/tactile highlight, and/or the like. For example a user may tap a “save” button to store his current settings. An example of a visual highlight is a border being displayed around the button upon the user tapping it. An example of an audio highlight is a “click” sound being played upon the user tapping the button. An example of a haptic highlight is a short vibration of the user device upon the user tapping the button.

A graphical user interface element may be considered a graphical user input element, in that a user may interact with the graphical user interface element to provide an input (for example, to select an option displayed as a button or check-box graphical user interface element, or control a variable by providing an input to a slider or dial graphical user interface element).

The apparatus may be configured to size the highlight to be larger for smaller sized graphical user interface elements and smaller for larger sized graphical user interface elements. The size of the highlight may be dependent upon the size of the graphical user interface element prior to the detected interaction.

The apparatus may be configured to provide the highlight associated with the graphical user interface element by differentially increasing the size of the visual highlight associated with a smaller graphical user interface element by a greater amount than the size of the visual highlight associated with a larger graphical user interface element. Therefore upon interaction with a small icon, a large border may be displayed around the icon so that the user can readily see that he/she has interacted with it. The small button without visual highlighting may be obscured by the stylus used to interact with it. The highlighting may thus provide an “enhanced size” so that the graphical user interface element is not obscured by the stylus when the highlighting is provided. A narrow border may be displayed around a large button upon a user interacting with the button, as the user may be able to readily see the border, even though it is narrow, because the button itself is large. A large button may not be obstructed even when an input element used to interact with the button (such as a pen, stylus, finger or hand) is located over/on the button, thus only a small highlight may be provided as the user can still see what they are interacting with.

The apparatus may be configured to provide the visual highlight associated with the graphical user interface element by differentially increasing the visual size of a smaller graphical user interface element by a greater amount than the visual size of a larger graphical user interface element. Therefore upon interaction with a small icon, the icon may be increased in size by a larger amount to a size which is not obscured by the stylus used to interact with it. Upon interaction with a large icon, the icon may be increased in size by a smaller amount to a size which is still not obscured by the stylus used to interact with it, but the increase in size required to ensure the icon is not obscured is less than required for a smaller icon.

The apparatus may be configured to differentially increase the size of the audio highlight by varying one or more of the magnitude, periodicity and frequency of an audio highlight associated with a smaller sized graphical user interface element by a different amount than an audio highlight provided to a larger graphical user interface element.

The apparatus may be configured to differentially increase the size of the haptic highlight by varying one or more of the magnitude, periodicity and frequency of a haptic highlight associated with a smaller sized graphical user interface element by a different amount than a haptic highlight provided to a larger graphical user interface element.

For example, the magnitude of a highlight may be varied by providing a quieter audible sound, and/or lighter vibration, upon interaction with a larger graphical user interface element, and a louder audible sound, and/or stronger vibration, for a smaller graphical user interface element. As another example, the frequency may be varied by providing a higher pitched audible sound, and/or a quicker vibration, upon interaction with a smaller graphical user interface element, and a lower pitched audible sound, and/or a slower vibration, for a larger graphical user interface element. As another example, the periodicity may be varied by providing a rapid series of tones and/or a quick series of vibration pulses upon interaction with a smaller graphical user interface element, and a slow separates series of tones and/or a slower series of vibration pulses for a larger graphical user interface element.

The apparatus may be configured to differentially increase the size of the visual highlight for a plurality of different sized graphical user interface elements, during respective detected interactions, to keep the effective visual size of the plurality of different sized graphical user interface elements substantially the same under respective interactions.

The apparatus may be configured to provide the visual highlight for a particular small sized graphical user interface element, the small sized graphical user interface element of a size to be obscured by the stylus used to interact with the small sized graphical user interface element when interacting with the graphical user interface element. For example, the visual highlight may be such that, once displayed over or around the graphical user interface element on a touch sensitive screen, the overall size of element plus highlighting is larger than a human finger pad, or a stylus for use with that touch sensitive screen. In other examples, the highlighting may render the effective size of the graphical user interface element (e.g., by providing a border or by enlarging the size of the graphical user interface element) to be a particular predetermined number of pixels (e.g., 28 pixels across), or dimension (e.g., 8 mm in diameter). The size of the stylus may be one or more of detected or predefined. The size may be determined by the apparatus (for example through detection by a touch sensitive screen), or by being pre-defined by a user or a pre-stored size according to a typical stylus size. Therefore the highlight may be provided such that the graphical user interface element plus highlighting is a particular size such that it is not obstructed from view when an input element, such as a pen, stylus, finger or hand user to interact with the graphical user interface element is positioned near, over or on it (for example, to press/touch it).

The apparatus may be configured to provide the highlight based on the size of the graphical user interface element prior to the detected interaction and the detected size of a stylus used during the interaction. Thus both the size of the graphical user interface element and the detected size of a stylus (e.g., a finger, or pen) are used to determine the size of a highlight to be provided.

The highlight may be provided to increase the size of the graphical user interface element by providing the highlight without increasing the actuatable area of the graphical user interface element. For example the highlight may be an audio effect when a user hovers a finger over a graphical user interface element, which does not cause the actuable area of the graphical user interface element to be changed.

The visual highlight may be provided to increase the size of the graphical user interface element by providing the visual highlight around the graphical user interface element without increasing the actuatable area of the graphical user interface element. Thus the highlight may be a border or visual effect, for example, which may be displayed by a pointer resting over the graphical user interface element, but if the highlight is clicked/double clicked on (rather than the graphical user interface element), clicking/double clicking will not cause the graphical user interface to open an application (whereas clicking/double clicking on the graphical user interface element itself would cause an application to open).

The visual highlight may be: a halo highlight around the perimeter of the graphical user interface element, a change in size of the graphical user interface element, a single colour border displayed around the user interface element, a single colour or multi-colour gradated border displayed around the user interface element, or a partially transparent coloured region over and/or around the user interface element.

The colour of the visual highlight may correspond to one or more of the type of graphical user interface element, the type of detected interaction with the graphical user interface element; and a user preference. For example, a visual highlight of an application icon graphical user interface element may be blue, whereas a visual highlight of a control graphical user interface element such as a slider or virtual dial may be yellow. As another example, interaction with an icon or graphical user interface element associated with a social networking application may be highlighted in blue. If there are unread messages or status updates in that application for the user, the highlight may be displayed differently (for example, as a larger highlight, a flashing highlight, or a highlight of a different colour such as deep blue, or red), in addition to the size of the highlight being based on the size of the social networking icon/graphical user interface element. As a further example, a displayed e-mail icon, when interacted with (for example, pre-selected by resting a mouse pointer over the icon or selected by the icon being clicked/tapped), may provide a highlight associated with any new e-mails which have been received, as well as the size of the highlight being based on the size of the email icon.

A further example relates to the type of the visual highlight corresponding to the type of graphical user interface element. For example, a visual highlight of a particular type may be used when interacting with a graphical user interface element which does not edit any content, and a different particular type of visual highlight may be used when interacting with a graphical user interface element which causes an edit or change of the content or device settings. As an example, a user may be provided with a static blue glow highlight (i.e., a particular type of highlight) when interacting with a slider or scroll bar to change the view, or when entering text into a search text box/field. These example inputs may be considered not to edit any content or change any device settings. Also, for example, a user may be provided with a flashing white glow and an audio output such as a beep (i.e., a different particular type of highlight) when entering text in a message or document in an edit mode, or changing an alarm clock setting. These example inputs may be considered to edit content and change device settings. In this example, a user may be able to learn from the displayed/received highlighting whether his inputs are related to a view-type mode, or an edit-type mode, and thus readily understand what sort of input he is making to his device.

A movement interaction with a graphical user interface element may cause a green visual highlight of the element, whereas a selection interaction with a graphical user interface element may be associated with a blue visual highlight and a deletion interaction with a graphical user interface element may be associated with a red visual highlight, for example. In certain examples a user may set their own personal preferences for which colours of visual highlight are provided.

The apparatus may be configured to increase the highlighting as the detected proximity of the interaction increases. The apparatus may be configured to increase the highlighting by one or more of an increase of the size of the highlight with increased proximity, an increase of the intensity of the highlight with increased proximity, and providing for or increasing periodicity of the highlight with increased proximity. For example, if an electronic device has a hover and touch sensitive display screen, a user finger hovering 3 cm away from the display screen may cause a small visual highlight and a light vibration to be provided, which may increase to a larger visual highlight and a stronger vibration as the user's finger approaches the display screen to touch it. Other example increases in highlighting include flashing a visual highlight on and off, and increasing the frequency of a series of vibrations or audio tones/beeps to enhance its effect for the user to notice.

The graphical user interface element may be configured for one or more of touch user input (including via the touchpad of a laptop computer and via a touch sensitive screen), hover user input and peripheral device user input (or example, by a mouse or keyboard).

The graphical user interface element may be a touch enabled graphical user interface element and the detected interaction may be a non-actuating proximity detection, based on the proximity of a stylus but which does not actuate the function performable by actuation interaction with the touch graphical user interface element.

The detected interaction may be an actuation interaction which actuates the function performable by the graphical user interface element.

The apparatus may be configured to remove the highlight when the interaction is no longer detected.

The apparatus may be configured to remove the highlight when actuation interaction of the graphical user interface element is detected, the actuation interaction providing for actuation of the function performable by the graphical user interface element.

The apparatus may be configured to visually highlight the graphical user interface element associated with the detected interaction from other graphical user interface elements not associated with the detected interaction. For example if a group of icons are displayed in a grid together, the apparatus may highlight one particular icon which is being interacted with, to cause it to stand out from the others in the group.

The apparatus may be configured to detect the interaction with the graphical user interface element.

The apparatus may be configured to determine the size of the user interface element.

The apparatus may be configured to determine the type of the detected interaction with the graphical user interface element and provide a highlight based on the determined type of the user interaction. For example the apparatus may determine that the type of interaction is a “move” input and provide a first type of highlight such as a blue border around the moved element. If the type of interaction is determined to be of an “actuate/open” type, then a second type of highlight such as a flashing green aura around the associated element may be provided. In this way a user may readily see what sort of interactions he is making, and what inputs he is providing, to the device.

The apparatus may be configured to allow a user to pre-define how highlighting is provided during a detected user interaction with a graphical user interface element. For example, a user may be able to select an ‘Enhanced Feedback’ setting to provide the highlighting according to examples disclosed herein in which the highlight is dependent upon the size of the graphical user interface element prior to the detected interaction. Another option may be to select a ‘Normal Feedback’ setting, to provide a different type of feedback which is not related to changing highlight size. Pre-defining how highlighting is provided may also include, for example, a user defining what is considered to be a “small sized”, “medium sized”, and “large sized” graphical user interface element in relation to providing highlighting dependent on the size of the graphical user interface element. These options may be presented as a menu of example highlight sizes, from which the user can select preferred sizes. A user may also choose particular combinations of highlighting which he finds particularly useful depending on his personal preferences. A user may be able to select vibration highlighting for actions associated with changing device settings, for example.

The apparatus may be configured to provide a highlight of a type associated with a particular connectivity of a device displaying graphical user interface elements. For example, if the device is coupled, or in operation with, an accessory, then this may cause a particular type of highlight to be provided. For example if a headset with headphones/microphone is connected to a mobile telephone device, then type A highlighting may be provided. If the mobile telephone device is connected to a battery charger, then type B highlighting may be provided. If the device is being wirelessly charged on a wireless charging apparatus, then type C highlighting may be provided. If the device has a connection to another device (e.g., a Bluetooth connection to a wireless headset, or to a laptop, or another electronic device) then type D highlighting may be provided.

The different types of highlighting may not be mutually exclusive. For example, a user may use a mobile telephone with a headset whilst the mobile telephone is connected to a charger to charge up the telephone battery. Both type A and type B highlighting may be provided to the user when interacting with a graphical user interface element. Type A highlighting may comprise a yellow border displayed around the edge of a graphical user interface element, whereas type B highlighting may comprise a flashing visual highlight (so the user in this example would see a flashing yellow border). The size of the highlight may also be dependent upon the size of the graphical user interface element prior to the detected interaction. Thus a narrow flashing yellow border may be displayed around a large graphical user interface element, and a wide flashing yellow border may be displayed around a small element. If the user unplugs the battery charger, the highlight borders would still be yellow (due to the headset being connected) but would no longer flash (as the device is not connected to a charger any longer).

The apparatus may be a portable electronic device, a laptop computer, a mobile phone, a Smartphone, a tablet computer, a personal digital assistant, a digital camera, a navigator, a server, a non-portable electronic device, a desktop computer, a monitor/display, or a module/circuitry for one or more of the same.

The graphical user interface element may be configured to receive input via one or more of a finger, a glove, a hand, a body part, a pen, a mechanical stylus, and a peripheral device. A peripheral device may be, for example, a mouse, a touch pad, a trackball, a pointing stick, a wand, a voice activated/microphone, or a joystick.

According to a further aspect, there is provided a computer program comprising computer program code, the computer program code being configured to perform at least the following:
during a detected interaction with a graphical user interface element, provide a highlight associated with the graphical user interface element, the size of the highlight dependent upon the size of the graphical user interface element prior to the detected interaction.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product.

According to a further aspect, there is provided a method, the method comprising:
providing a highlight associated with a graphical user interface element during a detected interaction with the graphical user interface element, the size of the highlight dependent upon the size of the graphical user interface element prior to the detected interaction.

According to a further aspect there is provided an apparatus comprising:
means for providing a highlight associated with a graphical user interface element during a detected interaction with the graphical user interface element, the size of the highlight dependent upon the size of the graphical user interface element prior to the detected interaction.

The present disclosure includes one or more corresponding aspects, embodiments or features in isolation or in various combinations whether or not specifically stated (including claimed) in that combination or in isolation. Corresponding means and corresponding function units (e.g. a highlight provider, such as a vibration unit, speaker or display, an interaction detector such as a touch or hover-sensitive screen, a graphical user interface element size determiner) for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus embodiment comprising a number of electronic components, including memory and a processor, according to one embodiment of the present disclosure;

FIG. 2 illustrates an example apparatus embodiment comprising a number of electronic components, including memory, a processor and a communication unit, according to another embodiment of the present disclosure;

FIG. 3 illustrates an example apparatus embodiment comprising a number of electronic components, including memory, a processor and a communication unit, according to another embodiment of the present disclosure;

FIGS. 4a-4b illustrate a visual highlight according to embodiments of the present disclosure;

FIGS. 5a-5c illustrate different sizes of visual, audio and haptic highlight for different sizes of graphical user interface elements, according to embodiments of the present disclosure;

FIGS. 6a-6c illustrate visual highlighting for different sizes of stylus interacting with a graphical user interface element, according to embodiments of the present disclosure;

FIGS. 7a-7d illustrate different sizes and different intensities of visual highlight depending on the proximity of the user's finger to a hover/touch sensitive display, according to embodiments of the present disclosure;

FIGS. 8a-8d illustrate visual highlighting of a graphical user interface element displayed in a group of graphical user interface elements when pre-selected and selected, according to embodiments of the present disclosure;

FIGS. 9a-9b illustrate an example apparatus in communication with a remote server/cloud, according to another embodiment of the present disclosure;

FIG. 10 illustrates a flowchart according to an example method of the present disclosure; and

FIG. 11 illustrates schematically a computer readable medium providing a program.

### DESCRIPTION OF EXAMPLE ASPECTS/EMBODIMENTS

A user may be able to interact with items displayed on a screen of an electronic device. For example, a user may be able to slide a scroll bar to read further down a page of displayed text, double click on an icon to open an application, drag an image from one area of the screen to another, or select an option by clicking on a box. If the device is an electronic device with a touch-sensitive display screen, the user may be able to interact with the displayed items by using his finger or a stylus on the screen.

A portable electronic device such as a smartphone or tablet computer may display graphical user interface elements, such as a sliders, buttons, icons and hyperlinks for example, which may be displayed and which may be relatively small in size. An element may be thought of as small in size if it is smaller than the end of the stylus (such as a pointer or finger) which may be used to interact with it, for example. Other graphical user interface elements may also be displayed in a group such that a plurality of graphical user interface elements is shown together in a grid, list, task bar, or menu, for example. Certain graphical user interface elements may both be relatively small in size and displayed in a group, for example a list of tracks on an album, wherein selection of a track title causes a device to play the track.

It may not always be clear to a user that he has actually interacted with a graphical user interface element. If the user has interacted with a graphical user interface element, it may not always be clear that he has interacted with the intended element. For example, a list of tracks on an album may be displayed on a portable media player with a touch sensitive screen, and a user may be able to select one of the tracks to add it to a compilation playlist by tapping the track name with his finger. If the track names are displayed in a relatively small font size, and displayed in a grouped way (i.e., in a list), then it may not be clear to the user which track he has selected if his finger obscures, or mostly obscures, the displayed track name when his finger is positioned over the track name to select it. If the finger touch input is not detected (for example the touch was too light, or was detected as a swipe rather than a tap), or if the user accidentally touches a different track name displayed next to the track name he intended to select, this may not be obvious to a user. The user may only realise their accidental mistake in not selecting the track he was interested in when reviewing the compilation list of selected tracks. In general, it may be frustrating for a user to use a device and not be clear which, if any, elements have been selected, for example due to their small size or due to being displayed in a group where a neighbouring element may easily be selected by mistake.

Further, it may not be desirable for an electronic device displaying graphical user interface elements to use the same methods of feedback regardless of the particular graphical user interface element selected or what sort of selection a user has made. For example, a user may be able to touch a large virtual button to press it, or move his stylus around the edge of a large virtual dial to rotate it. The user may not want to receive the same type of feedback for these actions as, for example, selecting a small displayed colour icon in a colour palette in a drawing application.

Examples disclosed here may be considered to provide a solution to one or more of the abovementioned problems. An apparatus is configured to provide a highlight associated with a graphical user interface element during a detected interaction with the graphical user interface element. The size of the highlight is dependent upon the size of the graphical user interface element prior to the detected interaction. Thus, a larger highlight may be provided for a smaller graphical user interface element to ensure the user is prompted in a clear way as to what he has selected. A large graphical user interface element may only require a subtle highlight as it may already be clear to the user, from the size of the graphical user interface element, that his interaction with it has been detected. Further examples are described in detail below.

Other embodiments depicted in the figures have been provided with reference numerals that correspond to similar features of earlier described embodiments. For example, feature number 100 can also correspond to numbers 200, 300 etc. These numbered features may appear in the figures but may not have been directly referred to within the description of these particular embodiments. These have still been provided in the figures to aid understanding of the further embodiments, particularly in relation to the features of similar earlier described embodiments.

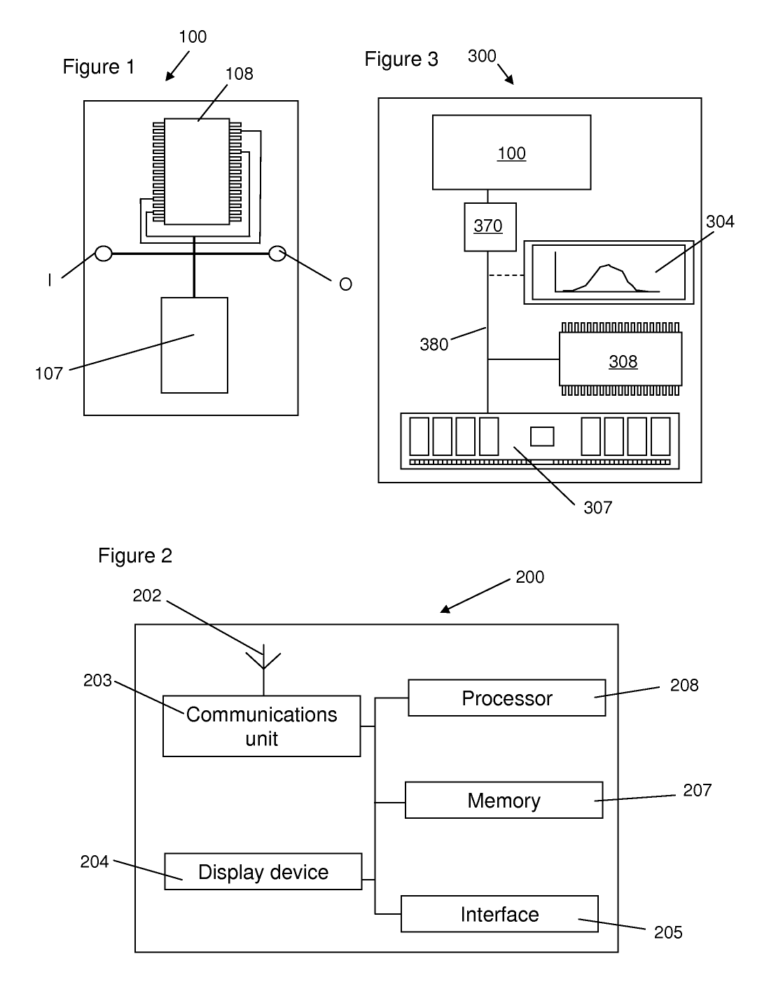

FIG. 1 shows an apparatus 100 comprising memory 107, a processor 108, input I and output O. In this embodiment only one processor and one memory are shown but it will be appreciated that other embodiments may utilise more than one processor and/or more than one memory (e.g. same or different processor/memory types).

In this embodiment the apparatus 100 is an Application Specific Integrated Circuit (ASIC) for a portable electronic device with a touch sensitive display. In other embodiments the apparatus 100 can be a module for such a device, or may be the device itself, wherein the processor 108 is a general purpose CPU of the device and the memory 107 is general purpose memory comprised by the device.

The input I allows for receipt of signalling to the apparatus 100 from further components, such as components of a portable electronic device (like a touch-sensitive display) or the like. The output O allows for onward provision of signalling from within the apparatus 100 to further components such as a display screen, speaker, or vibration module. In this embodiment the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 200 of a further example embodiment, such as a mobile phone. In other example embodiments, the apparatus 200 may comprise a module for a mobile phone (or PDA or audio/video player), and may just comprise a suitably configured memory 207 and processor 208. The apparatus in certain embodiments could be a portable electronic device, a laptop computer, a mobile phone, a Smartphone, a tablet computer, a personal digital assistant, a digital camera, a navigator, a server, a non-portable electronic device, a desktop computer, a monitor, or a module/circuitry for one or more of the same

The example embodiment of FIG. 2, in this case, comprises a display device 204 such as, for example, a Liquid Crystal Display (LCD), e-Ink or touch-screen user interface. The apparatus 200 of FIG. 2 is configured such that it may receive, include, and/or otherwise access data. For example, this example embodiment 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 200 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data).

FIG. 3 depicts a further example embodiment of an electronic device 300, such as a tablet personal computer, a portable electronic device, a portable telecommunications device, a server or a module for such a device, the device comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device may be a remote server accessed via the internet by the processor.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signalling to, and receiving signalling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

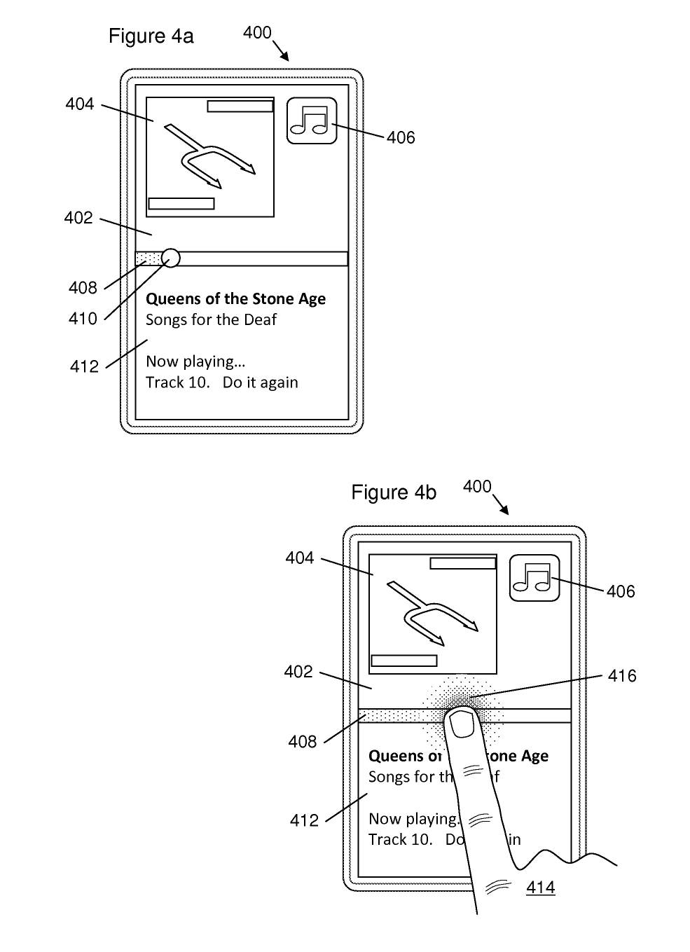

FIGS. 4a-4b illustrate an example embodiment of an apparatus/device 400 such as that depicted in FIGS. 1-3. The apparatus 400 is a portable electronic device such as a mobile phone, smartphone, personal media player or tablet computer. In this example, the apparatus 400 is being used as a music player 406, and is playing a song from an album. The alum artwork 404 and details of the artist, album, and song are shown 412.

The user is able to touch the slider button 410 and move the slider button 410 left along the slider 408 to rewind through the track, and move the slider button 410 right along the slider 408 to fast forward through the track. The slider button 410 is relatively small (the user's fingertip 414 is larger than the slider button 410) so that, when the user's finger 414 is located over the slider button 410 in order to move it, the slider button 410 can no longer be seen.

FIG. 4a shows the display screen before a user interaction. In FIG. 4b the user has positioned their finger 414 over the slider button 410 and is sliding their finger 414 to the right along the slider 408 to fast forward through the track. It will be appreciated that this example applies to any slider bar or similar graphical user interface element which may be moved over a screen (such as a scroll bar slider, an icon which may be re-positioned on a screen, or an element which can be moved in a game such as a chess piece or game character, for example).

FIG. 4b shows a visual highlight 416 being provided as a halo highlight 416 around the perimeter of the graphical user interface element 410. The halo highlight 416 is large enough so that it may be seen even though the user's finger 414 obscures the slider button 410. The size of the highlight 416 is dependent upon the size of the graphical user interface element 410 prior to the detected interaction 414, such that the highlight 414 can be seen despite the user's finger 414 covering the slider button 410.

Thus generally, FIGS. 4a-4b illustrate that, during a detected interaction 414 with a graphical user interface element 410, the apparatus 400 is configured to provide a highlight 416 associated with the graphical user interface element 410. The size of the highlight 416 is dependent upon the size of the graphical user interface element 410 prior to the detected interaction 414, in this case for example by being visually larger in area than the area of the user's finger touching the display.

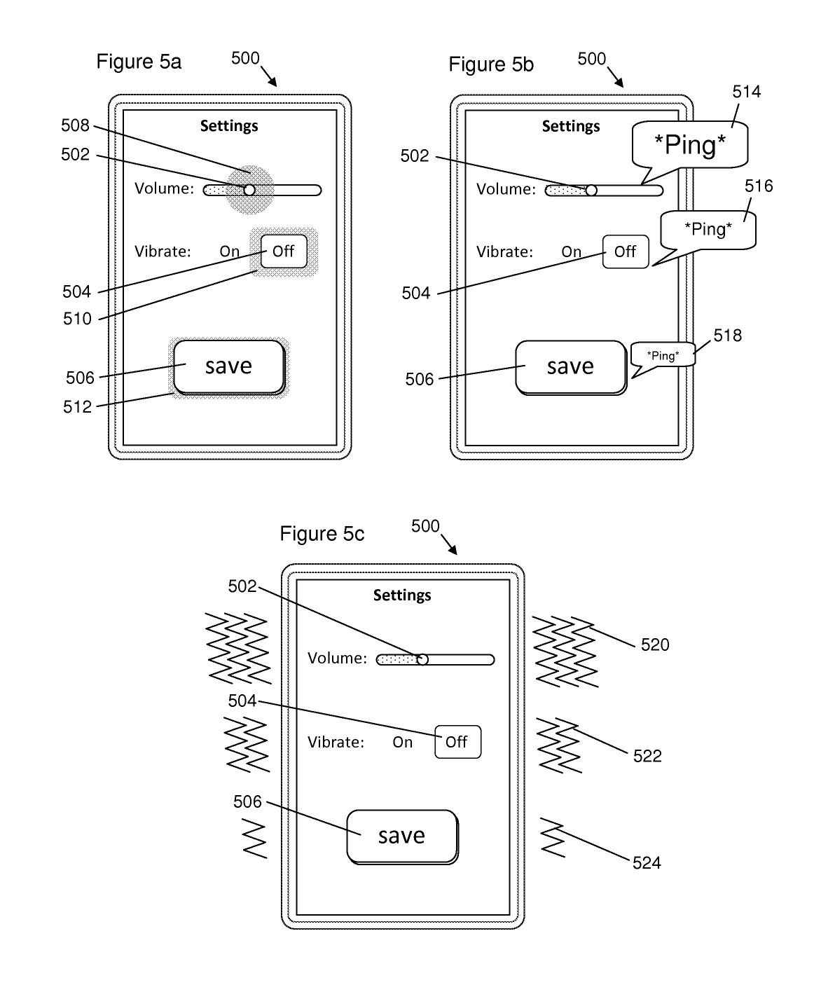

FIGS. 5a-5c illustrate an example embodiment of an apparatus/device 500 such as that depicted in FIGS. 1-3. The apparatus 500 is a portable electronic device such as a mobile phone, smartphone, personal media player or tablet computer. In this example, the apparatus 500 displays an example of graphical user interface elements of different sizes to illustrate how differential highlighting may be provided. A small slider button 502, a mid-sized selection box 504, and a large virtual button 506 are shown as examples.

The apparatus is configured to size the highlight to be larger for smaller sized graphical user interface elements and smaller for larger sized graphical user interface elements.

In FIG. 5a, the apparatus/device 500 is configured to provide a visual highlight 508, 510, 512 associated with the graphical user interface element 502, 504, 506 by differentially increasing the visual size of a smaller graphical user interface element by a greater amount than the visual size of a larger graphical user interface element. Thus for the small sized graphical user interface element 502, a large visual highlight 508 is provided as a broad coloured halo around the slider button 502. For the large graphical user interface element 506, a small visual highlight 512 is provided as a narrow border 512 around the large button 506. For the mid-sized graphical user interface element 504, a mid-sized visual highlight 510 is provided as a medium-width border 510 around the mid-sized button 504.

The apparatus 500 may be able to provide a highlight such that the overall size of the graphical user interface element 502, 504, 506 plus highlight 508, 510, 512 lies between a predetermined range of areas, such as an area which is bigger than a human fingerpad, or stylus. In this way the graphical user interface element 502, 504, 506 which is interacted with is highlighted 508, 510, 512 to the user so that the user can always see a highlight but the highlight does not overwhelm or dominate the overall displayed information. The highlight may be of a size sufficient in relation to the associated graphical user interface element that it is not obscured by a stylus used to interact with the element. The user may be able to see just enough of a highlight outside the area covered by their finger/stylus tip to know that they are interacting with the graphical user interface element. It may be considered that the apparatus 500 is configured to differentially increase the size of the visual highlight 508, 510, 512 for a plurality of different sized graphical user interface elements 502, 504, 506 during respective detected interactions, to keep the effective visual size of the plurality of different sized graphical user interface elements 502, 504, 506 substantially the same under respective interactions.

In certain examples, the apparatus may be configured to provide a visual highlight of a particular colour corresponding to the type of graphical user interface element. For example, a particular colour corresponding to the type of graphical user interface element may be provided. An application icon may have an associated blue visual highlight whereas a menu selection may have an associated green visual highlight. In certain examples, the apparatus may be configured to provide a visual highlight of a particular colour corresponding to the type of detected interaction with a graphical user interface element. For example a blue glow may be provided around a slider (moving) element and a yellow glow is provided around a button (stationary) element. In this way if an element may be interacted with both by movement or no movement (such as an icon which may be clicked without movement to open an associated application, or moved to reposition the icon on screen) then the colour of the visual highlight lets the user readily see what sort of interaction they are making.

As another example, a visual highlight may be provided as feedback if a user is interacting with a graphical user interface element in a forbidden way, or in a way which may give rise to a significant change (for example, a change which is not straightforward to reverse). For example, if a user drags a graphical user interface element to a recycle bin or a “delete” area, the visual highlight may change to a warning colour such as red when the graphical user interface element is located near to or over the bin/delete area. As another example if a user is trying to drag a graphical user interface element which does not move, or is trying to perform a user input which is not useable with a particular graphical user interface element, the visual highlight may change to indicate that this interaction is not allowed, for example by flashing, pulsing larger and smaller, or becoming brighter.

As another example, a visual highlight of a particular type may be provided as feedback depending on what type of data the user is interacting with. For example, if the user is interacting with a graphical user interface element which will affect material to be uploaded to a cloud based server, the highlight could be of type A (for example, a white visual glow around the graphical user interface element with a light vibration). If the user is interacting with a graphical user interface element which will affect material stored/handled locally on the device, then the highlight could be of type B (for example, a light blue visual highlight and no vibration). Thus the user is prompted and made aware of whether they are interacting with data locally or in relation to an external server/cloud. Of course, the different feedback types could have different visual (colour, size, flashing or static, etc.), audio and haptic/tactile aspects as described herein.

In certain examples, the apparatus may be configured to provide a visual highlight according to a user preference. For example, a user may not wish to use differentiating red and green visual highlights if they are red/green colour blind. In all the examples above, the user may be able to set personal preferences to customise their device.

FIG. 5b shows that the apparatus 500 is configured to differentially increase the size of the audio highlight by varying one or more of the magnitude, periodicity and frequency of an audio highlight associated with a smaller sized graphical user interface element by a different amount than an audio highlight provided to a larger graphical user interface element. A variation in the magnitude (i.e. volume) of the audio highlight is shown, such that for the small sized graphical user interface element 502, a loud audio highlight 514 is provided. For the large graphical user interface element 506, a quiet audio highlight 518 is provided. For the mid-sized graphical user interface element 504, a mid-volume audio highlight 516 is provided. Note that the audio outputs 514, 516, 518 are shown as being output from the respective graphical user interface elements 502, 504, 506 for the purposes of illustration and that audio output would be made from a speaker or set of headphones for example.

In other examples, the periodicity may be varied. For example, for a small sized graphical user interface element 502, a rapid series of beeps may be provided. For a large graphical user interface element 506, a slow series of beeps may be provided. For a mid-sized graphical user interface element 504, a mid-speed series of beeps may be provided. In further examples, the frequency may be varied. For example, for a small sized graphical user interface element 502, a high-pitched tone may be provided. For a large graphical user interface element 506, a low-pitched tone may be provided. For a mid-sized graphical user interface element 504, a mid-range tone may be provided.

FIG. 5c shows that the apparatus 500 is configured to differentially increase the size of the haptic highlight by varying one or more of the magnitude, periodicity and frequency of a haptic highlight associated with a smaller sized graphical user interface element by a different amount than a haptic highlight provided to a larger graphical user interface element. A variation in the magnitude (i.e. strength) of the haptic highlight is shown, such that for the small sized graphical user interface element 502, a strong vibration haptic highlight 520 is provided. For the large graphical user interface element 506, a weak vibration haptic highlight 5524 strength vibration haptic highlight 510 is provided. For the mid-sized graphical user interface element 504, a mid-strength vibration haptic highlight 522 may be provided. Note that the vibration outputs 520, 522, 524 are shown as being output from the respective graphical user interface elements 502, 504, 506 for the purposes of illustration.

In other examples, the periodicity may be varied. For example, for a small sized graphical user interface element 502, a rapid series of buzzes may be provided. For a large graphical user interface element 506, a slow series of buzzes may be provided. For a mid-sized graphical user interface element 504, a mid-speed series of buzzes may be provided. In further examples, the frequency may be varied. For example, for a small sized graphical user interface element 502, a rapid buzzing may be provided. For a large graphical user interface element 506, a slow rumble may be provided. For a mid-sized graphical user interface element 504, a mid-range vibration may be provided.

In the above and other examples, the size of a graphical user interface element may be defined in different ways. One such way is by the number of pixels. As an illustration, a graphical user interface element sized between 1 and 10 pixels may be classified as small and be associated with a large highlight of, for example, a 10-20 pixel-width border. A graphical user interface element sized from 30 or more pixels may be classified as large and be associated with a small highlight of, for example, a 1-3 pixel-width border. Elements sized between 11 and 29 pixels inclusive may be classified as mid-sized and be associated with a mid-sized highlight of, for example, a 4-19 pixel-width border. There may be different classifications of, for example, small, small-mid sized, mid-sized, mid-large sized and large sized graphical user interface elements. Other such measures of size include a display size, in a vertical or horizontal direction in millimetres, or a display area in pixels or mm². Any suitable measure may be used as will be appreciated.

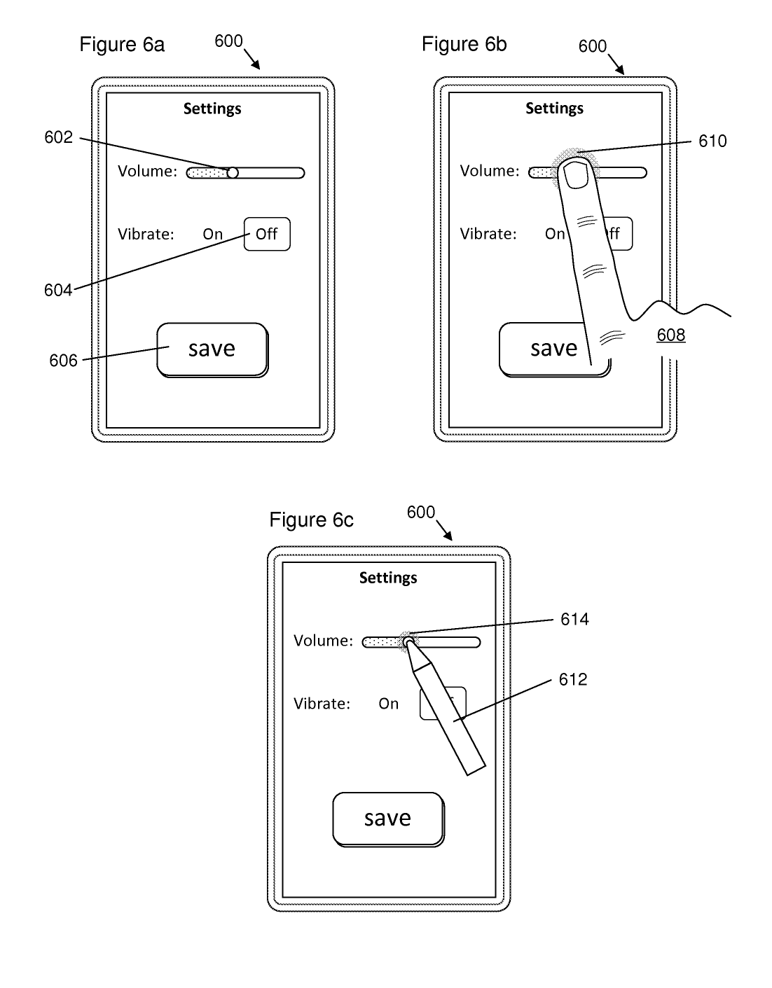

FIGS. 6a-6c illustrate an example embodiment of an apparatus/device 600 such as that depicted in FIGS. 1-3 with a touch sensitive screen. The apparatus 600 is a portable electronic device such as a mobile phone, smartphone, personal media player or tablet computer. In this example, the apparatus 600 displays an example of graphical user interface elements of different sizes. A small slider button 602, a mid-sized selection box 604, and a large virtual button 606 are shown as examples. The apparatus is configured to determine the size of the pointer used to interact with the graphical user interface element 602, 604, 606 and provide a visual highlight which is larger than the footprint of the pointer end by a particular amount.

FIG. 6a shows no pointer interaction and the relatively small size of the slider button 602 can be seen. In FIG. 6b, a user's finger 608 is used as a pointer. The user's finger 608 is interacting with the slider button 602, but the user's finger pad/end is larger than the slider button 602. The apparatus 600 is able to determine the size of the user's fingerpad and provide a visual highlight as a coloured border 620 around the slider button 602 so that the user can see that their interaction is detected. The apparatus is able to calculate an area which is larger than the detected area of the user's fingerpad over which to display a highlighted border, so that the user is able to see that his interaction with the slider button 602 is detected. It does not matter how large the user's finger 608 is, because the apparatus can adapt the size of the highlight to the size of the user's finger. If a new user with smaller fingers uses the apparatus, a smaller highlight may be provided which can be seen around the outside of the new user's fingerpad in contact with the display. Thus, the apparatus can provide the highlight based on the size of the graphical user interface element 602 prior to the detected interaction, and the detected size during the interaction. In this way a highlight is displayed which provides a visual cue to the user that their interaction has been detected without overwhelming the display and potentially obscuring, or distracting from, other displayed element on the screen.

In FIG. 6c, a user is using a stylus 612 as a pointer. The stylus 612 is interacting with the slider button 602, and the size of the end of the stylus is just smaller than the size of the slider button 602. The apparatus 600 is able to determine the size of the stylus 612 end and provide a visual highlight 614 as a small coloured border 614 around the slider button 602 so that the user can see that his interaction with the slider button 602 is detected. The size of the highlight 614 in this example is a narrow small border (e.g., 1 mm wide) around the slider button 602. The user may not require a large visual highlight as the slider button itself it visible, but since it is partially obscured, and to provide visual feedback to the user, a small border 614 is displayed.

The user may be able to switch between using a stylus as in FIG. 6c, and their finger as in FIG. 6b, and a visual highlight may be provided which is adapted to the detected size of the pointer used. If the display screen is configured for touch-detection with a gloved hand (for example a hover-sensitive screen) then the size of the gloved hand (which would be larger than an un-gloved finger) may be detected and a larger visual highlight provided as a result. The size of the pointer used may be determined by the apparatus as detected by the touch/hover sensitive screen in the above example. In other examples, the apparatus may be pre-configured to provide a visual highlight which is larger than the size of a particular stylus, for example if the user decides that for most or all of the time a particular stylus size will be used. These sizes may be selected from stored values for typical sizes (e.g., of fingers and/or pens) or input by a user to provide a specific stylus size dimension.

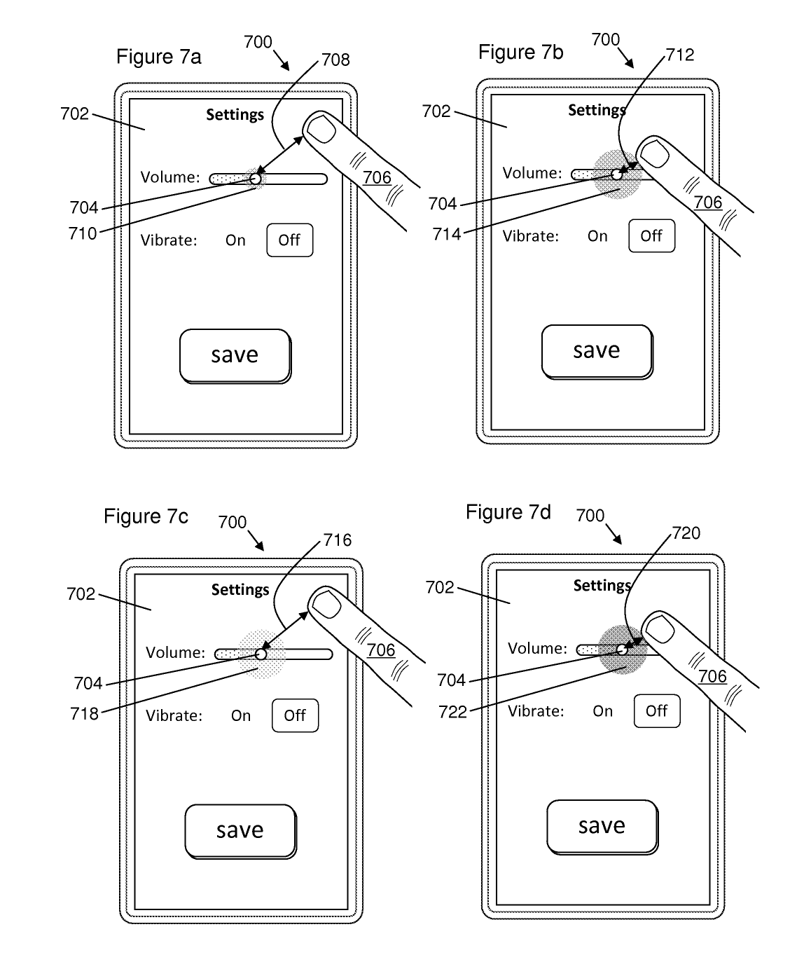

FIGS. 7a-7d illustrate an example embodiment of an apparatus/device 700 such as that depicted in FIGS. 1-3. The apparatus 700 is an electronic device with a touch and hover sensitive display screen 702 such as a mobile phone, smartphone, tablet computer or tabletop computer. In this example, the apparatus 700 displays example graphical user interface elements. The example volume slider button 704 is being interacted with by a user 706. The slider button 704 in this example is a touch enabled graphical user interface element, and the detected interaction is a non-actuating proximity detection, based on the proximity of a stylus 706, but which does not actuate the function performable by actuation interaction with the touch graphical user interface element. That is to say, the highlight is provided to show that the hovering user's finger 706 will, if it touches the highlighted element (or gets significantly close so that an actuation is detected), actuate a function associated with that element (in this case, increase or decrease volume), but the hovering itself does not actuate the volume control provided by the slider.

In FIG. 7a a user's finger 706 is hovering over the slider button 704 at a reasonably long, but detectable, distance away 708. A visual highlight 710 is provided as a small area/thickness highlighted border/halo around the slider button 704. The visual highlight 710 need not be particularly large as the user's finger 706 is a reasonable distance away 708 such that the slider button 704 is not significantly obscured. In FIG. 7b the user's finger 706 is hovering over the slider button 704 at a much closer distance 712 than in FIG. 7a. The visual highlight 714 provided is a highlighted border/halo with a larger area/thickness around the slider button 704. The visual highlight 714 in this case is larger than in FIG. 7a, as the user's finger 706 is much closer to the slider button 704 at the closer hover distance 712, thus partially obscuring it. The visual highlight 710, 714 therefore increases in area as the user's finger advances towards the slider button 704 to allow the user to clearly see what graphical user interface element he is about to interact with regardless of how close his finger is to the screen.

In FIG. 7c, similarly to FIG. 7a, a user's finger 706 is hovering over the slider button 704 at a reasonably long yet detectable distance away 716. A visual highlight 718 is provided as a pale/light highlighted border/halo around the slider button 704. The visual highlight 718 need not be particularly bright or bold as the user's finger 706 is a reasonable distance away 716 such that the slider button 704 is not obscured. In FIG. 7d, similarly to FIG. 7b, the user's finger 706 has moved closer to the display and to the slider button 704, and is hovering over the slider button 704 at a much closer distance 720 than in FIG. 7c. The visual highlight 722 provided is a bright, bold and vivid highlighted border/halo around the slider button 704. The visual highlight 722 in this case is much more obvious and striking than in FIG. 7c, as the user's finger 706 is much closer to obscuring the slider button 704 at the closer hover distance 720 so the visual highlight 722 is configured to make the graphical user interface element 704 stand out.

In certain examples, a combination of the effects shown in FIGS. 7a-7d may be provided such that as the user's finger 706 approaches the screen 702, the visual highlight becomes both larger and bolder. The visual highlight may be accompanied by (or alternatively provide), for example, a vibration of increasing strength as the user's finger approaches the screen 702, and/or a series of audio signals (e.g., beeps, tones or blips) which become more rapid as the user's finger approaches. The apparatus may be configured to allow the user to set his or her own preferential highlight parameters so that the user can customise their apparatus/device to provide highlighting which he/she finds particularly helpful and non-intrusive.

FIGS. 7a-7d and the above discussion overall illustrate that the apparatus 700 may be configured to increase the highlight as the detected proximity of the interaction increases. The highlighting may be increased by one or more of an increase of the size of the highlight with increased proximity, an increase of the intensity of the highlight with increased proximity, and providing for or increasing periodicity of the highlight with increased proximity.

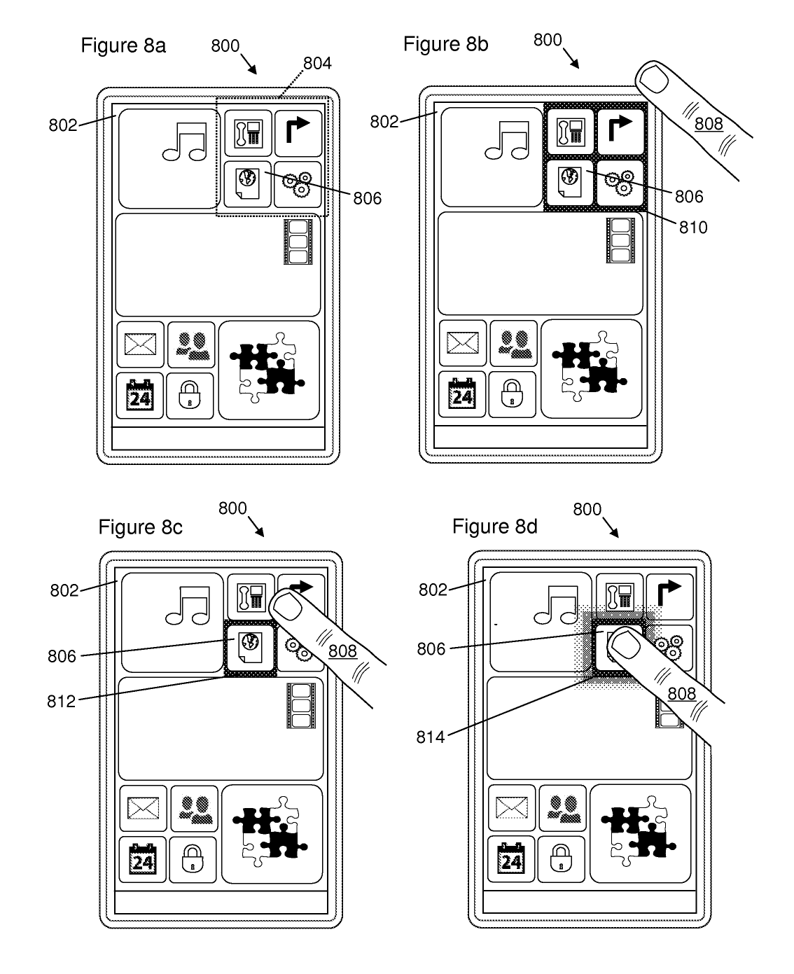

FIGS. 8a-8d illustrate an example embodiment of an apparatus/device 800 such as that depicted in FIGS. 1-3. The apparatus 800 is an electronic device with a touch and hover sensitive display screen 802 such as a mobile phone, smartphone, tablet computer or tabletop computer. In this example, the apparatus 800 displays a series of tiles/icons, each associated with a different application or functionality of the apparatus/device 800. Such a display may be provided as the home screen of a smartphone, for example. The apparatus/device 800 may have several such home screens available to a user. Example tiles/icons displayed on a home screen may be associated with, for example, a music player, calling capability, a GPS navigation application, an internet browser, a settings menu, a movie player, an e-mail application, a messaging application, a calendar application, a security application, and a game. In this example a user wishes to load the internet browser.

FIG. 8a shows a group of tiles/icons 804 in close proximity, in which the internet browsing tile/icon 806 is located. FIG. 8b shows a user's finger 808 hovering over the area 804 including the internet browsing tile/icon 806. The apparatus has detected the user's finger 808 in the hover-detection space above the display 802, and has provided a visual highlight 810 which includes the internet browsing tile/icon 810 as well as the neighbouring icons. This is because the user's finger has been detected by the apparatus/device 800 to be in a hover space over the internet browsing tile/icon 806, but because the user's finger is relatively far from the screen 802, the apparatus is not yet able to detect precisely which tile/icon the user will touch. Therefore all tiles/icons in the area 804 which the apparatus 800 has determined, based on the detected proximity of the user's hovering finger 808 may be touched, are highlighted.

In FIG. 8c, the user has moved their finger 808 closer to the touch and hover sensitive screen 802. Because of the closer proximity of the user's finger 808 to the screen 802, the apparatus/device 800 is now able to determine that if the user's finger continues to approach along the trajectory followed between FIGS. 8b and 8c, then the user's finger will touch the internet browsing tile/icon 806. The apparatus therefore provides a visual highlight 812 around only the internet browsing tile/icon since the user is most likely, unless he changes the position of his finger unexpectedly, to touch the internet browsing tile/icon 806.

In FIGS. 8b and 8c, since the user's finger is detected as a hover input to pre-select a tile/icon, the visual feedback 810, 812 provided is a coloured border around the edges of the tile(s)/icon(s) determined to be hovered over. In FIG. 8d, the user's finger 808 actually touches the internet browsing icon 806 to select it. The touch user input is detected and visual feedback 814 is provided to the user which is different to the feedback provided in response to the detected hover input. In this example the visual feedback 814 comprises a larger glowing border around the selected tile/icon 806 which spreads over neighbouring tiles and fades away from the centre of the selected tile/icon.

If the user wanted to select a larger tile/icon (or it was not clear which tile/icon of a group of tiles/icons was to be selected as in FIG. 8b), then the provided visual feedback may be a thinner border around the outside of the larger tile/icon or group of tiles/icons such as a 1-2 pixel thick line around the larger tile/icon edge or the edge of a group of tiles/icons as in FIG. 8b. Conversely, if the user wanted to select a smaller tile/icon or other smaller graphical user interface element on screen, the visual feedback may be a brighter and/or larger border which may spread over neighbouring displayed elements to make it clearer which element was to be selected (as in FIG. 8d).

As another example, if the user instead hovered their finger 808 over a social media or e-mail tile/icon, the associated visual highlight provided may correspond to the relative size of the tile/icon and also to other information related to that application. If there are unread messages and/or social media status updates, the visual highlight may flash, be displayed in a different colour, or be accompanied by a haptic and/or audio highlight to indicate that user attention is required (to read the messages), for example.

As another example, the density of the displayed user interface elements in the user interface may also affect the type of highlighting provided. For example, if many graphical user interface elements are displayed closely together in a user interface, a particular type of highlighting may be used, such as a brighter border around a selected element which spreads over neighbouring elements to make the selected element stand out visually while partially obscuring neighbouring non-selected elements. If the graphical user interface elements are not as closely positioned together, then a different type of highlighting for a particular selected element could be used, such as a fainter border which does not spread over neighbouring elements.

In general, FIGS. 8a-8d illustrate that the apparatus may be considered to visually highlight the graphical user interface element 806 associated with the detected interaction 808 from other graphical user interface elements not associated with the detected interaction. Further, the apparatus may be considered to detect the interaction (a distant hover, a close-proximity hover, and/or a touch user input) with the graphical user interface element 804, 806. Also, the apparatus may be considered to determine the type of the detected interaction with the graphical user interface element and provide a highlight based on the determined type of the user interaction. Thus in this case, a hover input causes a single colour line border to be displayed around the edge of the graphical user interface element(s) whereas a touch user input causes a broader fading-out coloured aura/glow to be displayed around the edge of the graphical user interface element.

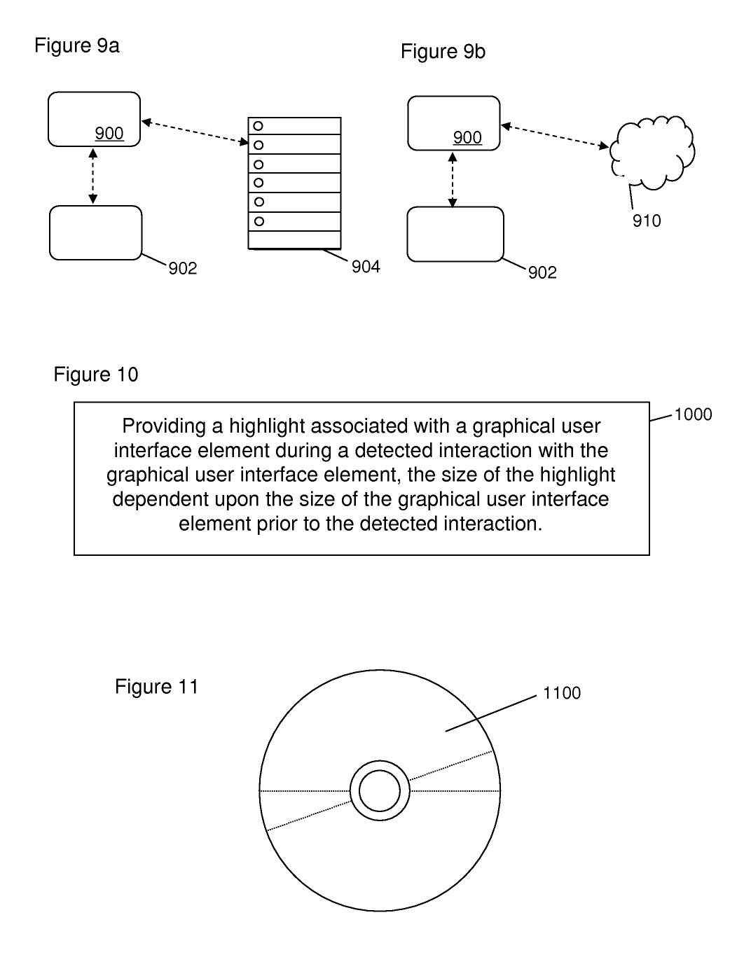

FIG. 9a shows an example of an apparatus in communication with a remote server. FIG. 9b shows an example of an apparatus in communication with a “cloud” for cloud computing. In FIGS. 9a and 9b, apparatus 900 (which may be apparatus 100, 200 or 300) is in communication with a display 902. The apparatus 900 and display 902 may form part of the same apparatus/device, although they may be separate as shown in the figures. The apparatus 900 is also in communication with a remote computing element. Such communication may be via a communications unit, for example.

FIG. 9a shows the remote computing element to be a remote server 904, with which the apparatus may be in wired or wireless communication (e.g. via the internet, Bluetooth, a USB connection, or any other suitable connection as known to one skilled in the art). In FIG. 9b, the apparatus 900 is in communication with a remote cloud 910 (which may, for example, be the Internet, or a system of remote computers configured for cloud computing). It may be that the determination of the type and/or size of highlight to be provided is performed remotely and communicated to the apparatus 900 for output. The apparatus 900 may actually form part of the remote sever 904 or remote cloud 910. In such examples, determination of the size/type of highlight to provide may be conducted by the server or in conjunction with use of the server.

FIG. 10 illustrates a method according to an example embodiment of the present disclosure. The method comprises the step of providing a highlight associated with a graphical user interface element during a detected interaction with the graphical user interface element, the size of the highlight dependent upon the size of the graphical user interface element prior to the detected interaction 1000.

FIG. 11 illustrates schematically a computer/processor readable medium 1100 providing a program according to an embodiment. In this example, the computer/processor readable medium is a disc such as a Digital Versatile Disc (DVD) or a compact disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
during a detected interaction with a graphical user interface element, provide a highlight associated with the graphical user interface element, the size of the highlight dependent upon the size of the graphical user interface element prior to the detected interaction.

2. The apparatus according to claim 1, wherein the highlight is one or more of a visual highlight, audio highlight and a haptic highlight.

3. The apparatus of claim 1, wherein the apparatus is configured to size the highlight to be larger for smaller sized graphical user interface elements and smaller for larger sized graphical user interface elements.

4. The apparatus of claim 1, wherein the apparatus is configured to provide the highlight associated with the graphical user interface element by differentially increasing the size of a smaller graphical user input element by a greater amount than the size of a larger graphical user input element.

5. The apparatus of claim 2, wherein the apparatus is configured to provide the visual highlight associated with the graphical user interface element by differentially increasing the visual size of the visual highlight associated with a smaller graphical user interface element by a greater amount than the visual size of the visual highlight associated with a larger graphical user interface element.

6. The apparatus of claim 2, wherein the apparatus is configured to differentially increase the size of the audio highlight by varying one or more of the magnitude, periodicity and frequency of an audio highlight associated with a smaller sized graphical user interface element by a different amount than an audio highlight provided to a larger graphical user interface element.

7. The apparatus of claim 2, wherein the apparatus is configured to differentially increase the size of the haptic highlight by varying one or more of the magnitude, periodicity and frequency of a haptic highlight associated with a smaller sized graphical user interface element by a different amount than a haptic highlight provided to a larger graphical user interface element.

8. The apparatus of claim 2, wherein the apparatus is configured to differentially increase the size of the visual highlight for a plurality of different sized graphical user interface elements, during respective detected interactions, to keep the effective visual size of the plurality of different sized graphical user interface elements substantially the same under respective interactions.

9. The apparatus of claim 2, wherein the apparatus is configured to provide the visual highlight for a particular small sized graphical user interface element, the small sized graphical user interface element of a size to be obscured by the stylus used to interact with the small sized graphical user interface element when interacting with the graphical user interface element.

10. The apparatus of claim 9, wherein the size of the stylus is one or more of detected or predefined.
increase of the intensity of the highlight with increased proximity; and
providing for or increasing periodicity of the highlight with increased proximity.

18. (canceled)

19. The apparatus of claim 1, wherein the graphical user interface element is a touch enabled graphical user interface element and the detected interaction is a non-actuating proximity detection, based on the proximity of a stylus, but which does not actuate the function performable by actuation interaction with the touch graphical user interface element.

20. (canceled)

21. (canceled)

22. (canceled)

23. (canceled)

24. (canceled)

25. (canceled)

26. (canceled)

27. (canceled)

28. A computer readable medium comprising computer program code stored thereon, the computer readable medium and computer program code being configured to, when run on at least one processor perform at least the following:
during a detected interaction with a graphical user interface element, provide a highlight associated with the graphical user interface element, the size of the highlight dependent upon the size of the graphical user interface element prior to the detected interaction.

29. A method comprising:
providing a highlight associated with a graphical user interface element during a detected interaction with the graphical user interface element, the size of the highlight dependent upon the size of the graphical user interface element prior to the detected interaction.
